(19) United States
(12) Patent Application Publication
(10) Pub. No.: US 2026/0079267 A1
(43) Pub. Date: Mar. 19, 2026

(54) GEOGRAPHIC NAVIGATION SATELITE SYSTEM ERROR MODELING

(71) Applicant: GM Global Technology Operations LLC, Detroit, MI (US)

(72) Inventors: Bo Yu, Troy, MI (US); Guanyang Luo, Warren, MI (US); Nasir Sharaf, Royal Oak, MI (US); Kamran Ali, Troy, MI (US); Shuqing Zeng, Sterling Heights, MI (US); Hua Su, Austin, TX (US)

(21) Appl. No.: 18/886,216

(22) Filed: Sep. 16, 2024

(51) Int. Cl. G01S 19/48

(52) U.S. Cl. CPC G01S 19/485

(57) ABSTRACT

A vehicle includes a controller having a global navigation system satellite (GNSS) positioning module and a sensor fusion module. A plurality of vehicle sensors are connected to the controller. The sensor fusion module includes software configured to fuse sensor data from the plurality of vehicle sensors and a GNSS position by applying an error weight to each element of data from the plurality of vehicle sensors and the GNSS position. The error weight of the GNSS position is variable dependent upon a GNSS error model map.

### INTRODUCTION

The subject disclosure relates to vehicles, and in particular to determining weighting values to assign to geographic navigation satellite system (GNSS) positioning within a sensor fusion system of a vehicle.

Vehicles with built in autonomous and/or semi-autonomous navigation systems include multiple sources of sensor information. The sensor information provides fixed positioning information of the vehicle, relative positioning information of the vehicle and surrounding elements, and information regarding the operations of the vehicle. The sensor information is then used by various vehicle systems to aid in vehicle operations.

In some cases, one or more sensor types on the vehicle and in communication with the vehicle may provide values that conflict for the same data point. By way of example, a GNSS system may indicate that the vehicle is in one position, however map data and sensor data may indicate a different position. To account for these discrepancies, as well as to account for different margins of error between different sensors, a sensor fusion system combines the sensor outputs and applies a weighting to each similar data point.

Accordingly, it is desirable to provide a system for determining an expected accuracy of a GNSS position datapoint and assign a weight to the GNSS position corresponding to the expected accuracy.

### SUMMARY

In one exemplary embodiment a vehicle includes a controller having a global navigation system satellite (GNSS) positioning module and a sensor fusion module. A plurality of vehicle sensors are connected to the controller. The sensor fusion module includes software configured to fuse sensor data from the plurality of vehicle sensors and a GNSS position by applying an error weight to each element of data from the plurality of vehicle sensors and the GNSS position. The error weight of the GNSS position is variable dependent upon a GNSS error model map.

In addition to one or more of the features described herein the GNSS error model map is divided into a plurality of spatial regions and wherein each spatial region has a corresponding expected GNSS error.

In addition to one or more of the features described herein the corresponding expected GNSS error accounts for at least one of GNSS signal blockage and GNSS multi-path errors.

In addition to one or more of the features described herein the corresponding expected GNSS error is based on a variation between a relative position of the vehicle determined via the plurality of vehicle sensors and a GNSS position of the vehicle determined by the GNSS positioning module.

In addition to one or more of the features described herein the relative position of the vehicle is determined via comparing an output of the plurality of vehicle sensors to a point cloud map of a region in which a vehicle is operating.

In addition to one or more of the features described herein the relative position of the vehicle is determined via comparing an output of the plurality of vehicle sensors to a semantic map of a region in which a vehicle is operating.

In addition to one or more of the features described herein the expected GNSS error of each spatial region is based on a discrepancy variance of observation points within the spatial region.

In addition to one or more of the features described herein the expected GNSS error of each spatial region is interpolated across multiple observation points within the spatial region.

In addition to one or more of the features described herein the interpolation is at least one of a splines based interpolation, a kriging based interpolation, a nearest neighbor based interpolation, and a natural neighbor based interpolation.

In addition to one or more of the features described herein the GNSS error model map is derived from a plurality of vehicles.

In another exemplary embodiment a method for fusing sensor data on a vehicle includes applying an error weight to each element of data from a plurality of vehicle sensors and a GNSS position. The error weight of the GNSS position is variable dependent upon a GNSS error model map and a location of a vehicle.

In yet another exemplary embodiment the GNSS error model map is divided into a plurality of spatial regions and wherein each spatial region has a corresponding expected GNSS error.

In yet another exemplary embodiment the corresponding expected GNSS error accounts for at least one of GNSS signal blockage and GNSS multi-path errors.

In yet another exemplary embodiment the corresponding expected GNSS error is based on a variation between a relative position of the vehicle determined via the plurality of vehicle sensors and a GNSS position of the vehicle determined by the GNSS positioning module.

In yet another exemplary embodiment the relative position of the vehicle is determined via comparing an output of the plurality of vehicle sensors to a point cloud map of a region in which a vehicle is operating.

In yet another exemplary embodiment the relative position of the vehicle is determined via comparing an output of the plurality of vehicle sensors to a semantic map of a region in which a vehicle is operating.

In yet another exemplary embodiment the expected GNSS error of each spatial region is based on a discrepancy variance of observation points within the spatial region.

In yet another exemplary embodiment the expected GNSS error of each spatial region is interpolated across multiple observation points within the spatial region.

In yet another exemplary embodiment the interpolation is at least one of a splines based interpolation, a kriging based interpolation, a nearest neighbor based interpolation, and a natural neighbor based interpolation.

In yet another exemplary embodiment the GNSS error model map is derived from a plurality of vehicles.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a vehicle including a controller and multiple sensor systems;

FIG. 2 is a sensor fusion architecture for the vehicle of FIG. 1;

FIG. 3 is an illustration of potential global navigation satellite system (GNSS) errors resulting from an urban canyon environment;

FIG. 4 is a general process for generating a GNSS error map;

FIG. 5 illustrates a first embodiment of the general process of FIG. 4;

FIG. 6 is a point cloud map generated within the process of FIG. 5;

FIG. 7 demonstrates a relative local positioning mapping using a point cloud of FIG. 6;

FIG. 8 illustrates spatial regions within the point cloud data of FIG. 7;

FIG. 9 illustrates a second embodiment of the general process of FIG. 4;

FIG. 10 illustrates semantic map data generated in the process of FIG. 9; and

FIG. 11 illustrates relative local positioning mapping of the semantic map data of FIG. 10.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

As used herein the term controller refers to a dedicated processor and memory, a distributed control architecture including multiple dedicated processors in communication with each other, remote processing systems in communication with a local passthrough processors, or any similar processing architecture able to exert control in the described manner.

In accordance with an exemplary embodiment, a fleet of vehicles provides distributed sensor data and global navigation satellite system (GNSS) position data to a central system. The central system leverages local maps to determine the positions of each vehicle in the fleet relative to the local maps (referred to as the relative positions). The relative positions are associated with GNSS positions determined by the GNSS at the same time. Based on the differences between the relative positions and the associated GNSS positions, an error model identifying a probability of GNSS position error is established at the central system. The central system divides the map into spatial regions based on an expected GNSS error determined by the error model. The combined set of spatial regions is referred to as an error map and is distributed from the central system to one or more vehicles.

In alternative embodiments, the GNSS error map may be generated by a controller, entirely local to the vehicle using relative positions and GNSS positions generated by the vehicle through multiple passes in the same map area.

In yet further alternative embodiments, the GNSS error map may be generated by a controller local to the vehicle using a data set of relative positions and associated GNSS positions received from the central system.

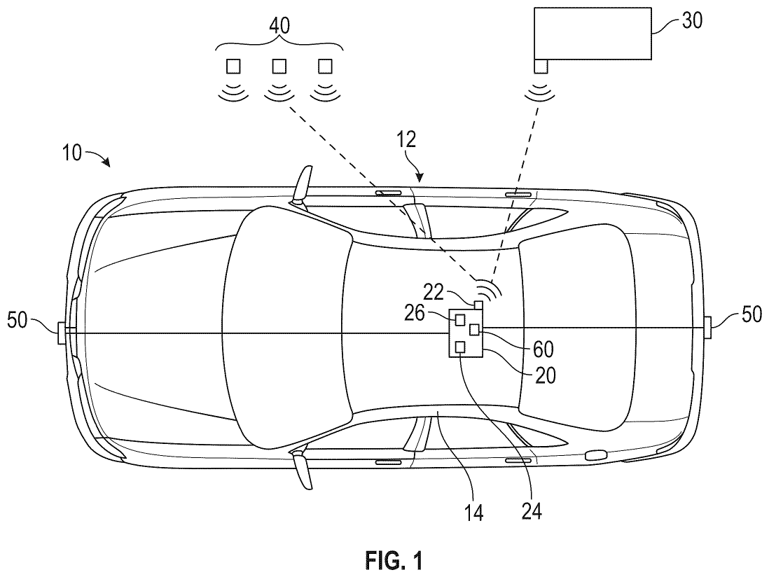

Turning to a detailed explanation of some embodiments, FIG. 1 illustrates a vehicle 10, including a body 12 and a passenger compartment 14. Within the vehicle 10 is a controller 20. The controller 20 includes a communication system 22 in communication with a central computing system 30 and a set of GNSS satellites 40. The communication system is in some examples multiple receivers and transmitters configured to communicate with distinct external systems. In addition, the controller 20 is in communication with multiple vehicle sensors 50 configured to provide relative positioning information about the vehicle. Included within the controller 20 is a sensor fusion module 24 and a GNSS error map module 26.

The vehicle sensors 50 can include inertial motion units, wheel odometers, cameras, light and any number of additional sensors and sensor types able to contribute to a determination of a relative position of the vehicle 10. The vehicle 10 may be part of a fleet of similar vehicles, where each vehicle 10 in the fleet includes similar sensing, positioning, and processing capabilities.

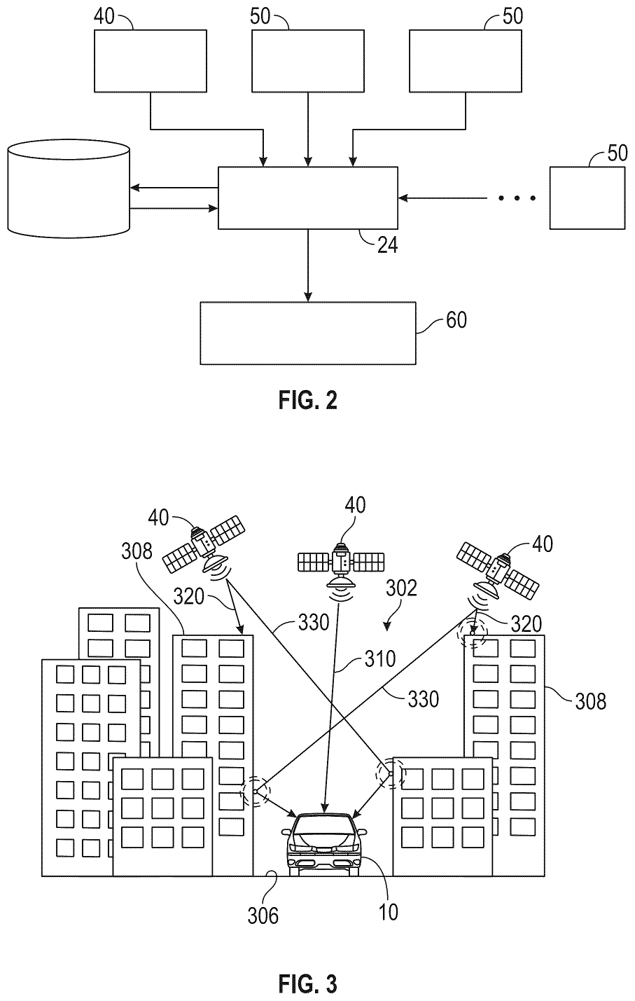

With continued reference to FIG. 1, FIG. 2 illustrates an example architecture of the sensor fusion module 24. The sensor fusion module 24 receives data from multiple sources including the GNSS positioning from the GNSS satellites 40 and sensor outputs from each of the vehicle sensors 50, and combines the multiple sources of data into a single position of the vehicle. The position is then provided to one or more downstream modules 60 such as autonomous or semi-autonomous vehicle operation modules.

In order to properly synthesize potentially disagreeing data (e.g., different vehicle positions) from the multiple sources of data, the sensor fusion module 24 applies a weight to each data source for a given piece of information (e.g., each data source providing vehicle location information), with a heavier weight corresponding to a higher degree of accuracy expected from that particular source.

Sources such as the vehicle sensors 50 have a generally consistent accuracy, and the particular weight of data from that source is fixed in the sensor fusion module 24. The accuracy of GNSS position data, however, varies substantially based on a number of factors including orbital errors, satellite clock errors, ionospheric delay, tropospheric delay, multipath and signal blockage, and receiver noise. Existing systems for estimating GNSS accuracy typically focus on accounting for orbital errors, satellite clock errors, ionospheric delay, and tropospheric delay as the quantity and magnitude of multipath and signal blockage errors are highly location dependent.

With continued reference to FIGS. 1 and 2, FIG. 3 illustrates the vehicle 10 proceeding through an urban canyon environment 302. An urban canyon environment is a place where a street 306 is flanked by buildings 308 on both sides creating a canyon-like environment. GNSS operates by timing a travel time of a signal from a satellite 40 with a known orbital position to the vehicle 10. When the signal is direct and unobstructed, such as the center signal 310 an accurate position of the vehicle 10 relative to the satellite 40 originating the signal 310 can be determined. Using at least three such signals, an absolute geospatial position of the vehicle 10 can be calculated to a degree of accuracy of the GNSS positioning system.

When a building 308 blocks a signal (e.g., signals 320) a signal blockage error occurs, and the reduced number of available GNSS signals causes a decrease in accuracy of the determined position.

Similarly, when a signal 330 reflects off a building 308, or other object, and is then received by the vehicle 10, the travel time of the signal 330 is artificially increased, and the accuracy of the determined position is decreased.

In order to address the decreased accuracy resulting from blocked signals 320 and multi-path signals 330, sensor data from the vehicle sensors 50 is provided to the central computing system 30 to create a local map of the location. The local map includes landmarks (e.g., lane lines, road signs, images of buildings, trees, and other fixed structures) as well as vehicle trajectories. For any given pair of data points (e.g. a pair of vehicles 10 passing through the area or multiple passes through the same area of a single vehicle 10), the relative positions of the vehicles 10 can be calculated from the local map and using the GNSS positioning. By assuming the accuracy of the local map, a geographic GNSS error model is created based on the discrepancy between the relative positions on the local map and the relative positions from the GNSS measurements.

With continued reference to FIGS. 1-3, FIG. 4 illustrates a process 400 for generating the local error map. Initially a fleet of vehicles, including the vehicle 10 of FIG. 1, generates paired location points using vehicle sensors 50 and a local map as well as GNSS positioning. The paired location points are provided to the central computing system 30 at a first step 410.

Once the data has been provided to the central computing system 30, a new local map is created based on the data from the vehicle sensors 50 for the specific location in a create local map step 420. In some examples, a high definition (HD) map of the area may already exist and be available, in which case the vehicle sensor data 50 is applied to the existing HD map to further improve the local map instead of creating a new map.

The local map includes reference images and sensor data allowing a vehicle 10 to be precisely positioned by comparing images and sensor data from the vehicle sensor 50 to the locations of the reference images and sensor data in a calculate relative positions using local map step 430.

Simultaneously with determining the relative position using the local map, the process 400 calculates the GNSS position based on the GNSS measurements in a calculate GNSS positions step 440.

After both sets of positions are created in steps 430 and 440 the central computing system 30 divides the local map into spatial regions in a divide map step 450. The spatial regions can be uniformly distributed geographic blocks, traffic blocks, regions of a city, or any other existing division of the local map.

A GNSS error model is computed for each spatial region of the local map in a create GNSS error model step 460, and the GNSS error model is distributed to each vehicle 10 configured to utilize the local map.

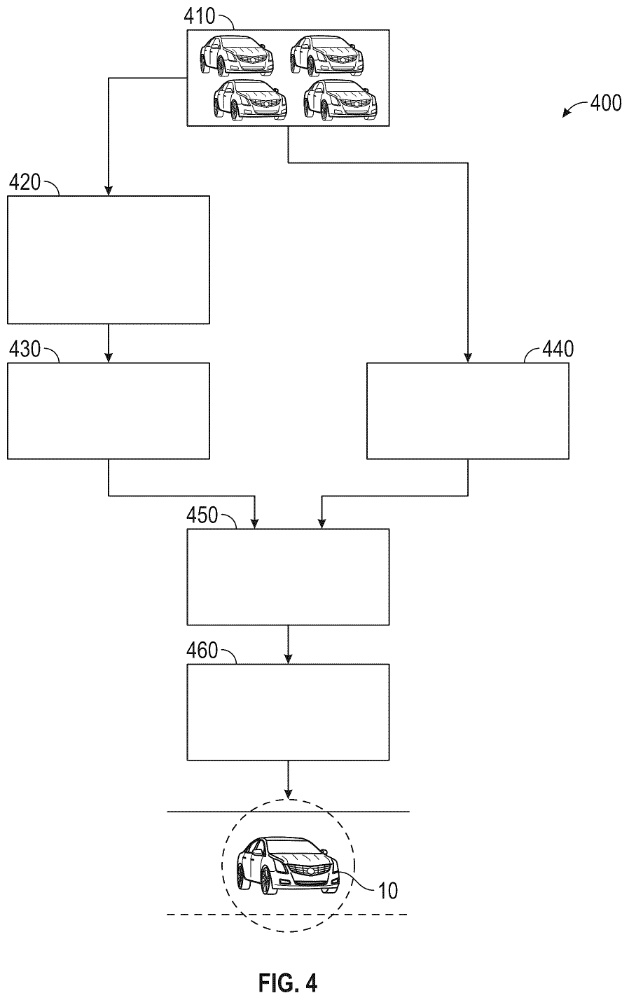

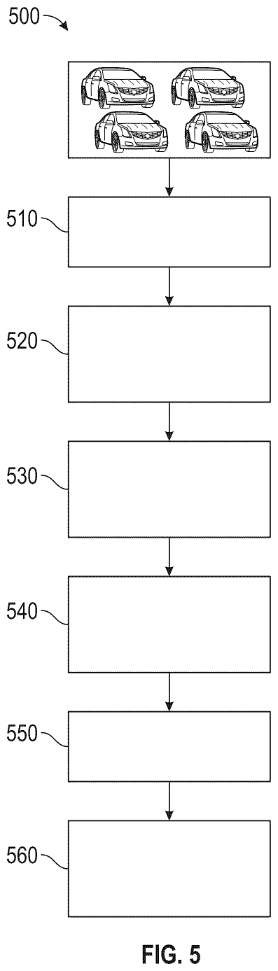

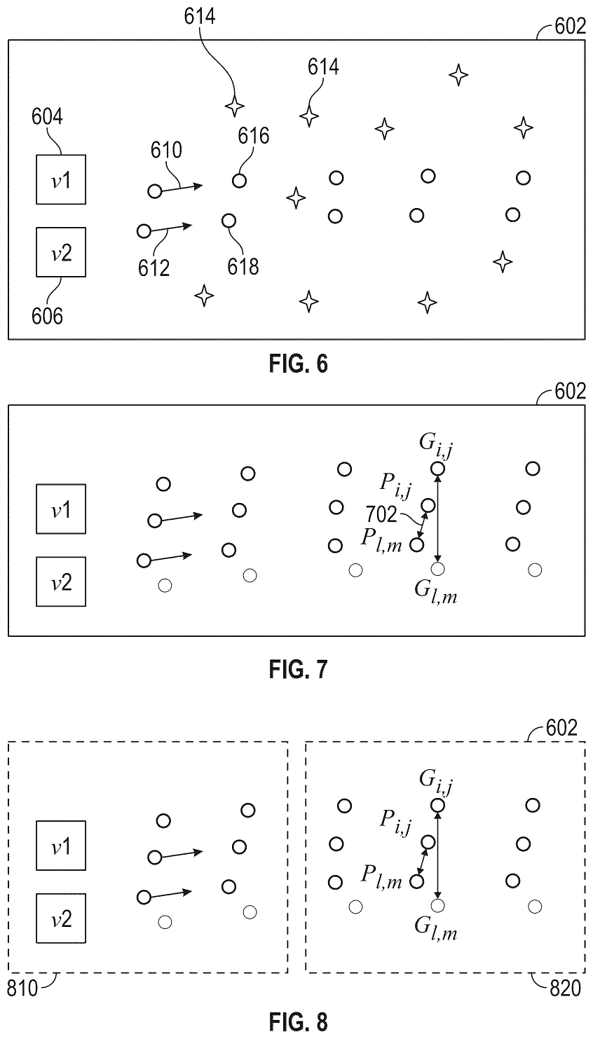

With continued reference to FIGS. 1-4, FIGS. 5-8 illustrate a process 500 for performing the process 400 of FIG. 4 using high precision point cloud maps generated by the vehicle sensors 50, with FIG. 5 illustrating a flowchart of the process, FIG. 6 illustrating a point cloud map 602 generated by steps 510 and 520 of the process, FIG. 7 illustrating relative position offset calculations of steps 530, 540, and FIG. 8 illustrating the division of the point cloud and the local map 602 into spatial regions 810, 820.

Initially raw images and a simultaneous localization and mapping (SLAM) algorithm are used to create a point cloud map 602 that aligns with a real world coordinate system such as latitude and longitude in a create point cloud map step 510. By way of example, the SLAM algorithms can include OrbSLAM, VinsFusion, Structure From Motion (SFM), or any similar SLAM algorithm. The map 602 includes at least two vehicles 604, 606, and defines the vehicle trajectories 610 (corresponding to vehicle 604) and 612 (corresponding to vehicle 606). The map 602 further includes multiple reference points 614, and vehicle positions 616, 618 along the corresponding trajectories 610, 612.

The process 500 aligns the point cloud map 602 with the world coordinate system in an alignment step 520, and calculates the relative positions of the vehicles 604, 606 using the point cloud map 602 in a calculate positions step 530 and using the GNSS measurements in a calculate positions step 540. The relative positions are defined by an offset 702 between one vehicle position and a nearby vehicle position such that for any given point P_{i,j}, the given point has relative position to a neighboring point can be P_{i,j}−P_{l,m} and for any given point P_{i,j}, the corresponding GNSS position G_{i,j}'s relative position to a neighboring point's GNSS position is G_{i,j}−G_{l,m}.

After determining the relative positions, the point cloud map 602 is divided into spatial regions 810, 820, FIG. 8, in a divide local maps into spatial regions step 550.

After dividing the map into spatial regions the discrepancy of the relative positions from steps 530 540 are used to calculate the GNSS error within that region in a create GNSS error model for each spatial region step 560. In one example, the GNSS error model is calculated according to:

$$\begin{matrix}{discrepency}_{( i , j ) - ( l , m )} = ( {G}_{i , j} - {G}_{l , m} ) - ( {P}_{i , j} - {P}_{l , m} ) \\ discrepency\_variance = {Variance}_{i , l j , m} ( {disc r epency}_{( i , j ) - ( l , m )} ) \\ GNSS\_error \_variance = \frac{discrepency\_variance}{2}\end{matrix}$$

Where the discrepancy is the difference between each relative position and the corresponding GNSS position, the discrepancy variance is the variation of the discrepancies throughout the spatial regions 810, 820, and the GNSS error variance is the error value assigned to the regions 810, 820 in the GNSS error model.

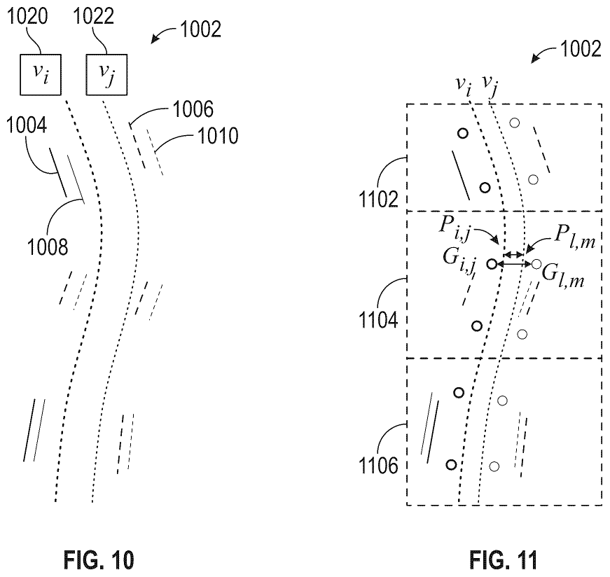

With reference again to FIGS. 1-4, FIGS. 9-11 illustrate a process 900 for performing the process 400 of FIG. 4 using semantic-based local maps. Initially the process 900 receives the crowd sourced local data from the vehicles 10 and creates a new semantic map 1002 (illustrated in FIG. 10) in a create semantic map step 910. The semantic map can be created via any existing semantic map algorithm, and tracks semantic features of the road on which the vehicle 10 is traveling such as lane lines 1004, 1008 curbs 1006, 1010 and the like. In the example of FIG. 10, a first vehicle 1020 tracks a first set of semantic features (lane lines 1004 and curbs 1006) and a second vehicle 1022 tracks a second set of semantic features (lane lines 1008 and curbs 1010).

In cases where an existing HD map created using semantic features exists, the existing map can be leveraged in combination with the new data from the vehicle sensors 50 to create an updated local map.

Based on the semantic map 1002, the relative positions of the vehicles 1020, 1022 are determined in a calculate relative positions using semantic maps step 912 and a GNSS position is determined using GNSS signals in a calculate position using GNSS measurements step 914.

After identifying both the relative position and the GNSS position, the semantic map 1002 is divided into spatial regions 1102, 1104, 1106, FIG. 11, in a divide local maps into spatial regions step 916, and a GNSS error model is created for each spatial region in a create GNSS error model step 918.

Calculation of the GNSS error model for one example point is illustrated in FIG. 11, spatial region 1104. For the given point P_{i,j}, a cross-track offset to a neighboring point P_{l,m} is calculated by P_{i,j}−P_{l,m}. Then, for the point P_{i,j}, the corresponding GNSS offset to a neighboring point P_{l,m} is calculated by G_{i,j}−G_{l,m}. With these reference points, the GNSS error model is:

$$\begin{matrix}{discrepency}_{( i , j ) - ( l , m )} = ( {G}_{i , j} - {G}_{l , m} ) - ( {P}_{i , j} - {P}_{l , m} ) \\ discrepency\_variance = {Variance}_{i , l j , m} ( {disc r epency}_{( i , j ) - ( l , m )} ) \\ GNSS\_cross \_track \_error \_variance = \frac{discrepency\_variance}{2}\end{matrix}$$

Where the discrepancy is the difference between each relative position and the corresponding GNSS position, the discrepancy variance is the variation of the discrepancies throughout the spatial region 810, 820, and the GNSS error variance is the error value assigned to the region 810, 820 in the GNSS error model.

With reference to both the process 500 and the process 900, given a minimum threshold of granularity in the error measurements, one or more algorithms may be used to interpolate the error measures between the observation points, providing a more complete GNSS error map. By way of example, interpolation can be in the form of one or more Spline based algorithm, kriging (alternately referred to as Gaussian process regression) based algorithm, nearest neighbor based algorithm, and/or natural neighbor based algorithm. Interpolating the observation points improves the output of the GNSS error map by incorporating the weight given to error estimates coming from different observation points.

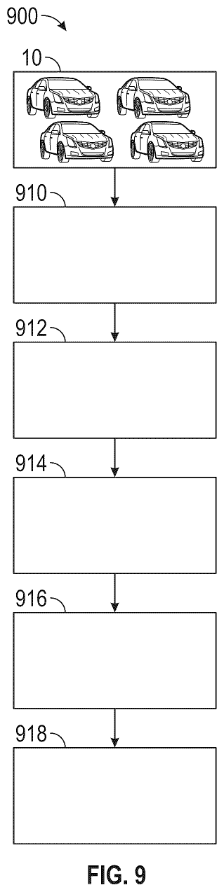

While described and illustrated as separate examples in FIGS. 4 and 9, it is appreciated that the GNSS error map may be generated using a combination of both the point cloud based process 500 of FIG. 4 and the semantic map based process 900 of FIG. 9.

Furthermore, while the described herein with regards to passage through an urban canyon environment, it is appreciated that the systems and features are applicable to an environment in which a vehicle 10 passes through an environment where multipath and/or signal blockage positioning error is likely to occur.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A vehicle comprising:
a controller having a global navigation system satellite (GNSS) positioning module and a sensor fusion module;
a plurality of vehicle sensors connected to the controller;
the sensor fusion module including software configured to fuse sensor data from the plurality of vehicle sensors and a GNSS position by applying an error weight to each element of data from the plurality of vehicle sensors and the GNSS position, and wherein the error weight of the GNSS position is variable dependent upon a GNSS error model map.

2. The vehicle of claim 1, wherein the GNSS error model map is divided into a plurality of spatial regions and wherein each spatial region has a corresponding expected GNSS error.

3. The vehicle of claim 2, wherein the corresponding expected GNSS error accounts for at least one of GNSS signal blockage and GNSS multi-path errors.

4. The vehicle of claim 2, wherein the corresponding expected GNSS error is based on a variation between a relative position of the vehicle determined via the plurality of vehicle sensors and a GNSS position of the vehicle determined by the GNSS positioning module.

5. The vehicle of claim 4, wherein the relative position of the vehicle is determined via comparing an output of the plurality of vehicle sensors to a point cloud map of a region in which a vehicle is operating.

6. The vehicle of claim 4, wherein the relative position of the vehicle is determined via comparing an output of the plurality of vehicle sensors to a semantic map of a region in which a vehicle is operating.

7. The vehicle of claim 2, wherein the expected GNSS error of each spatial region is based on a discrepancy variance of observation points within the spatial region.

8. The vehicle of claim 7, wherein the expected GNSS error of each spatial region is interpolated across multiple observation points within the spatial region.

9. The vehicle of claim 8, wherein the interpolation is at least one of a splines based interpolation, a kriging based interpolation, a nearest neighbor based interpolation, and a natural neighbor based interpolation.

10. The vehicle of claim 1, wherein the GNSS error model map is derived from a plurality of vehicles.

11. A method for fusing sensor data on a vehicle comprising:
applying an error weight to each element of data from a plurality of vehicle sensors and a GNSS position, and wherein the error weight of the GNSS position is variable dependent upon a GNSS error model map and a location of a vehicle.

12. The method of claim 11, wherein the GNSS error model map is divided into a plurality of spatial regions and wherein each spatial region has a corresponding expected GNSS error.

13. The method of claim 12, wherein the corresponding expected GNSS error accounts for at least one of GNSS signal blockage and GNSS multi-path errors.

14. The method of claim 12, wherein the corresponding expected GNSS error is based on a variation between a relative position of the vehicle determined via the plurality of vehicle sensors and a GNSS position of the vehicle determined by a GNSS positioning module.

15. The method of claim 14, wherein the relative position of the vehicle is determined via comparing an output of the plurality of vehicle sensors to a point cloud map of a region in which a vehicle is operating.

16. The method of claim 14, wherein the relative position of the vehicle is determined via comparing an output of the plurality of vehicle sensors to a semantic map of a region in which a vehicle is operating.

17. The method of claim 12, wherein the expected GNSS error of each spatial region is based on a discrepancy variance of observation points within the spatial region.

18. The method of claim 17, wherein the expected GNSS error of each spatial region is interpolated across multiple observation points within the spatial region.

19. The method of claim 18, wherein the interpolation is at least one of a splines based interpolation, a kriging based interpolation, a nearest neighbor based interpolation, and a natural neighbor based interpolation.

20. The method of claim 11, wherein the GNSS error model map is derived from a plurality of vehicles.
